(19) United States
(12) Patent Application Publication
(10) Pub. No.: US 2006/0075049 A1
(43) Pub. Date: Apr. 6, 2006

(54) Program product enabling effective use of computer storage area

(75) Inventor: Shigenori Matsubara, Ashiya-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 11/016,989

(22) Filed: Dec. 21, 2004

(30) Foreign Application Priority Data
Sep. 21, 2004 (JP) 2004-273788

(51) Int. Cl. G06F 15/16

(52) U.S. Cl. 709/206

(57) ABSTRACT

A program product, which cooperates with an e-mail program having a function of forming an e-mail with an application program data attached, causes a computer to execute the steps of: storing an edition data processed by an application program in a storage unit of the computer; passing information for forming an edition-data-attached e-mail, that is, an e-mail having the stored edition data attached thereto, to the e-mail program; and deleting the edition data stored in the storage unit in response to a notice from the e-mail program indicating that the edition-data-attached e-mail has been formed.

This application is based on Japanese Patent Application No. 2004-273788 filed with Japan Patent Office on Sep. 21, 2004, the entire content of which is hereby incorporated by reference.

### BACKGROUND OF THE INVENTION

1. Field of the Invention

The present invention relates to a program product and, more specifically, to a program product that enables effective use of a storage area of a computer.

2. Description of the Related Art

As a method of transferring and receiving a file through a network, use of an electronic mail (e-mail) with a file attached thereto (hereinafter also referred to as a file-attached e-mail) has been known (this method will be also referred to as e-mail file transfer).

In e-mail file transfer, management of the file attached to the e-mail is problematic. By way of example, if the attached file becomes unnecessary after transmission of the file-attached e-mail, the attachment file undesirably occupies a hard disk capacity.

Methods of efficiently managing attachment files have been disclosed in Japanese Laid-Open Patent Publication Nos. 2003-36232, 2003-122689 and 2002-158690.

According to the techniques disclosed in Japanese Laid-Open Patent Publication Nos. 2003-36232, 2003-122689 and 2002-158690, however, if an attachment file becomes unnecessary after transmitting the file-attached e-mail, it is necessary for the user to manually delete the attachment file.

When a file attached to a received e-mail is to be edited and the edited file is to be transmitted as an attachment to a return mail, it is necessary for the user to temporarily save the edited file in a hard disk and to attach the file to the return mail manually. This is a troublesome task for the user.

In some cases, the edited file to be attached to the e-mail may be unnecessary. If the edited file should contain some confidential information, the secret information might possibly be leaked unless the edited file is deleted. Further, the unnecessary edited file undesirably occupies hard disk capacity.

### SUMMARY OF THE INVENTION

Therefore, an object of the present invention is to provide a program product that enables a computer to effectively utilize its storage area.

According to as aspect, the present invention provides a program product that cooperates with an e-mail program having a function of transmitting/receiving an e-email and a function of forming an e-mail with an application program data attached thereto, and the program product causes a computer to execute the steps of: storing an edition data processed by an application program in a storage unit of the computer; passing information to form an edition-data-attached e-mail having the edition data stored in the storage unit attached thereto, to the e-mail program; deleting, in response to a notice from the e-mail program that the edition-data-attached e-mail has been formed, the edition data stored in the storage unit.

Preferably, the program product causes the computer to further execute the steps of: receiving a user's instruction to form an e-mail; and storing an edition data processed by an application program in a storage unit of the computer in response to the instruction.

Preferably, the edition-data-attached e-mail is a return mail to an e-mail received by the e-mail program.

Preferably, the storage unit has a mail address list stored therein, and when the e-mail program receives an e-mail with the data of an application program attached thereto, the program product causes a computer to execute the steps of: reading information related to a transmission source of the e-mail with the data of the application program attached thereto, and if the read information of transmission source is included in the mail address list, passing information for forming an edition-data-attached e-mail, to the e-mail program.

Preferably, the program product has a module operating as a plug-in of the application program.

Preferably, the program product causes the computer to further execute the step of: deleting the edition data such that recovery of the edition data from the storage unit is fully prevented.

Preferably, the storage unit stores the data in a non-volatile manner.

According to another aspect, the present invention provides a program product that cooperates with an e-mail program having a function of transmitting/receiving an e-mail and a function of forming an e-mail with an application program data attached thereto, and the program product causes a computer to execute the steps of: after an edition-data-attached e-mail having the edition data formed by the application program and stored in the storage unit attached thereto is transmitted by the e-mail program, analyzing information of the edition data attached to the edition-data-attached e-mail; and deleting the edition data stored in the storage unit in accordance with the analysis of the edition data.

Preferably, the edition-data-attached e-mail is a return mail to an e-mail received by the e-mail program.

Preferably, the program product has a module operating as a plug-in of the application program.

Preferably, the program product causes the computer to further execute the step of: deleting the edition data such that recovery of the edition data from the storage unit is fully prevented.

Preferably, the storage unit stores the data in a non-volatile manner.

According to a further aspect, the present invention provides a program product that cooperates with an e-mail program having a function of transmitting/receiving an e-email and a function of forming an e-mail with an application program data attached thereto, and the program product causes a computer to execute the steps of: receiving a user's instruction to form a e-mail; storing an edition data processed by an application program in a storage unit of the computer in response to the instruction; and passing information for forming an edition-data-attached e-mail, that is, an e-mail having the edition data stored in the storage unit attached thereto, to the e-mail program.

According to a still further aspect, the present invention provides a program product that cooperates with an e-mail program having a function of transmitting/receiving an e-mail and a function of forming an e-mail with an application program data attached thereto, and the program product causes a computer to execute the steps of: receiving an instruction to form an e-mail having an edition data formed by the application program and stored in the storage unit of the computer attached thereto; reading attribute of the stored edition data in response to the instruction; and passing information to form the e-mail to the e-mail program, in accordance with the read attribute of the edition data.

Preferably, the e-mail program forms an e-mail in accordance with the read attribute of the edition data.

Preferably, the information is return information to the e-mail received by the e-mail program.

According to the present invention, the edition data attached to the edition-data-attached e-mail is automatically deleted, and therefore, hard disk capacity is not wasted. As a result, the storage area of the hard disk can effectively be utilized. Further, as the edition data is automatically deleted, it becomes unnecessary for the user to delete the edition data through troublesome manual operation.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically represents a network system capable of transmitting/receiving an e-mail, in accordance with a first embodiment of the present invention.

FIG. 2 is a block diagram representing an internal configuration of a PC in accordance with the embodiment.

FIG. 3 shows a list of mail addresses.

FIG. 4 is a functional block diagram representing mutual relations among a plurality of software programs activated by a control unit.

FIG. 5 shows a table of mail data.

FIG. 6 is an image displaying e-mail contents.

FIG. 7 is an image of an application program showing an activated application program.

FIG. 8 shows an exemplary file configuration used in the present embodiment.

FIG. 9 is a flow chart representing a process performed by a mailer and an application program in accordance with the present embodiment.

FIG. 10 is a flow chart representing a file editing process.

FIG. 11 is an image representing a return mail.

FIG. 12 is a flow chart representing a mail editing process.

FIG. 13 is a flow chart representing a mail transmitting process.

FIG. 14 is a an image representing a new e-mail.

FIG. 15 is a block diagram representing an internal configuration of a PC in accordance with a second embodiment.

FIG. 16 is a functional block diagram representing mutual relations among a plurality of software programs activated by a control unit in accordance with the second embodiment.

FIG. 17 is an image of an application program showing an activated application program.

FIG. 18 is a flow chart representing a process performed by a mailer and an application program in accordance with the second embodiment.

FIG. 19 is a block diagram representing an internal configuration of a PC in accordance with a third embodiment.

FIG. 20 is a functional block diagram representing mutual relations among a plurality of software programs activated by a control unit in accordance with the third embodiment.

FIG. 21 represents a received mail viewing image of a mailer in accordance with the third embodiment.

FIGS. 22A and 22B are flow charts representing a process performed by a mailer and an application program in accordance with the third embodiment.

FIG. 23 is an image of an application program showing an activated application program.

FIG. 24 is an image representing a new e-mail

FIG. 25 is an image representing a return mail.

### DESCRIPTION OF THE PREFERRED EMBODIMENTS

Embodiments of the present invention will be described in the following with reference to the figures. In the following description, same or corresponding portions are denoted by the same reference characters, and names and functions thereof are also the same. Therefore, detailed description thereof will not be repeated.

### First Embodiment

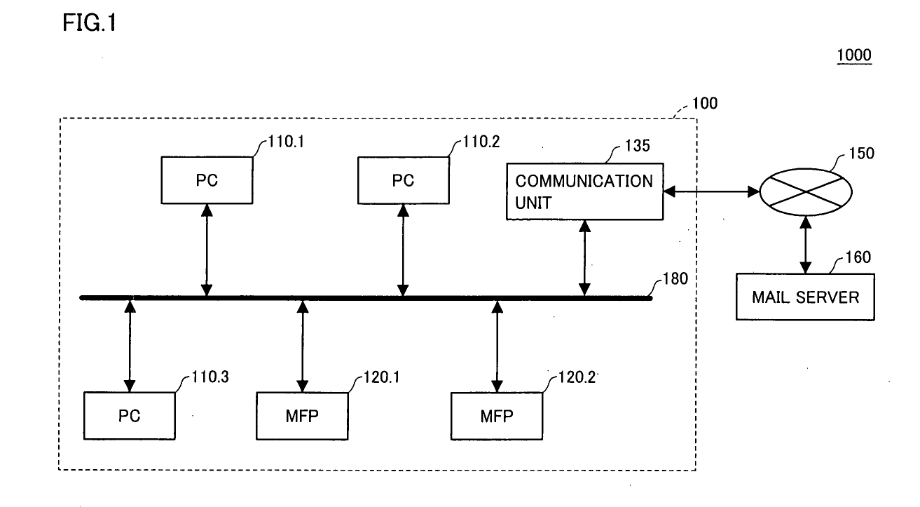

Referring to FIG. 1, a network system 1000 includes a network 100, an external network 150 such as the Internet, and a mail server 160.

Network 100 includes a network circuit 180, personal computers (hereinafter also denoted by PCs) 110.1, 110.2 and 110.3, multi function peripherals (hereinafter also denoted by MFPs) 120.1 and 120.2, and a communication unit 135. MFPs 120.1 and 120.2 have a plurality of functions including the functions of a printer, a facsimile and a scanner.

Communication unit 135 performs wired or wireless data communication with network circuit 180. Communication unit 135 performs data communication with network 150. Communication unit 135 is a communication interface (such as a router) utilizing Ethernet (Registered Trademark).

Further, communication unit 135 may be any communication interface that performs data communication utilizing wired or wireless LAN technique, such as IEEE 802.11a, IEEE802.11b or IEEE802.11g as a wireless LAN standard.

Network 150 is connected to mail server 160.

Mail server 160 temporarily stores an e-mail data received from network 100 or e-mail data addressed to a device in network 100.

Each of PCs 110.1, 110.2 and 110.3 performs wired or wireless data communication with network circuit 180. A unique IP address is allotted to each of PCs 110.1, 110.2 and 110.3.

Each of MFPs 120.1 and 120.2 performs wired or wireless data communication with network circuit 180. A unique IP address is allotted to each of MFPs 120.1 and 120.2. In the following, PCs 110.1, 110.2 and 110.3 will be generally denoted by PC 10, and MFPs 120.1 and 120.2 will be generally denoted by MFP 120.

Network 100 of the present embodiment is not limited to the configuration above. By way of example, one or more PCs and one or more MFPs may be connected to the network, one or more PCs only may be connected to the network, or one or more MFPs only may be connected to the network.

Network system 1000 of the present embodiment is not limited to the configuration above, either. By way of example, mail server 160 may be provided inside the network 100.

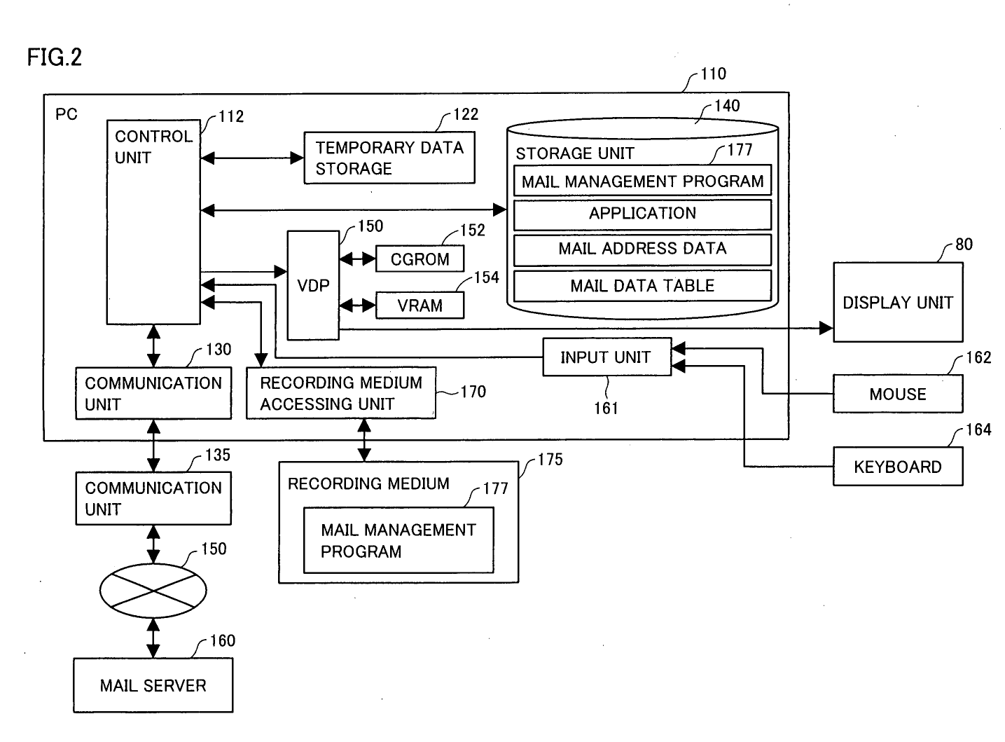

FIG. 2 is a block diagram representing an internal configuration of PC 110 in accordance with the present embodiment. For easier description, communication unit 135, network 150, mail server 160 and a recording medium 175 are also shown in FIG. 2.

Referring to FIG. 2, a display unit 80, a mouse 162 and a keyboard 164 are connected to PC 110.

Display unit 80 displays an image based on image data output from PC 110. Display unit 80 may be a liquid crystal display (LCD), a cathode ray tube (CRT), a field emission display (FED), plasma display panel (PDP), organic electro luminescence (EL) display, a dot matrix display, or a display device of any other type.

Mouse 162 is an interface for the user to operate PC 110.

Keyboard 164 is an interface for the user to operate PC 110.

PC 110 includes a control unit 112, a temporary data storage 122, a storage unit 140, a communication unit 130, a VDP (Video Display Processor) 150, a CGROM (Character Graphic Read Only Memory) 152, a VRAM (Video Random Access Memory) 154, an input unit 161 and a recording medium access unit 170.

CGROM 152 stores image data for generating an image to be displayed on display unit 80, such as font data and figure data.

Storage unit 140 stores a mail management program 177, application program data, mail address data, a mail data table and the like, to have control unit 112 perform a prescribed process. Storage unit 140 is data-accessed by control unit 112. Storage unit 140 is a hard disk that can store a large amount of data. Storage unit 140 is not limited to a hard disk, and it may be any medium that can retain data (such as a flash memory) even when power is not supplied.

Specifically, storage unit 140 may be an EPROM (Erasable Programmable Read Only Memory) that allows unlimited number of erasure and writing, an EEPROM (Electrically Erasable and Programmable Read Only Memory) of which content can be electrically rewritten, an UV-EPROM (Ultra-Violet Erasable Programmable Read Only Memory) allowing unlimited number of erasure and writing by ultra-violet ray, or any other circuit that has a structure allowing storage and retention of data in a non-volatile manner.

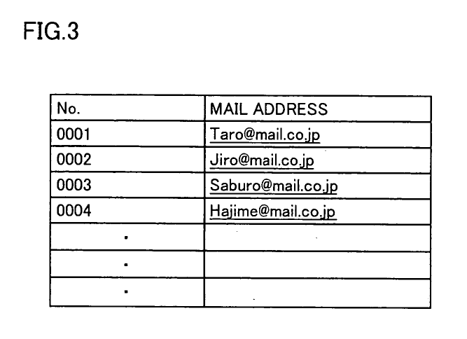

FIG. 3 shows the mail address data.

The mail address data represents data of a list having mail addresses of frequent recipients of return mail.

Again referring to FIG. 2, control unit 112 has a function of performing operations and various processes related to components inside PC 110 in accordance with a mail management program 177 stored in storage unit 140.

Further, control unit 112 issues an instruction to VDP 150 to generate an image and to display the image on display unit 80 (hereinafter also referred to as “image display instruction”), in accordance with the application program data and mail management program 177 stored in storage 140.

Control unit 112 may be a microprocessor, an FPGA (Field Programmable Gate Array) that is a programmable LSI (Large Scale Integration), an ASIC (Application Specific Integrated Circuit) that is an integrated circuit designed and manufactured for a specific application, or any other circuit having an operating function.

VDP 150 is connected to display unit 80. VDP 150 reads necessary image data from CGROM 152 in response to an image display instruction from control unit 112, and generates an image using VRAM 154. Then, VDP 150 reads the image data stored in VRAM 154 and displays an image on display unit 80 based on the image data.

VRAM 154 has a function of temporarily storing the image generated by VDP 150.

Temporary data storage 122 is accessed for data by control unit 112, and is used as a work memory that temporarily stores data.

Temporary data storage 122 may be an RAM (Random Access Memory) that can temporarily store data, an SRAM (Static Random Access Memory), a DRAM (Dynamic Random Access Memory), an SDRAM (Synchronous DRAM), a DDR-SDRAM (Double Data Rate SDRAM) that is an SDRAM having a high data transfer function of double data rate mode, an RDRAM (Rambus Dynamic Random Access Memory) that is a DRAM adopting a high speed interface technique developed by Rambus Inc., a Direct-RDRAM (Direct Rambus Dynamic Random Access Memory), or any other circuit that has a structure allowing storage and retention of data in a volatile manner.

Mouse 162 and keyboard 164 are connected to input unit 161. An input instruction from mouse 162 or keyboard 164 is transmitted through input unit 161 to control unit 112. Control unit 112 performs a prescribed process in accordance with the input instruction from input unit 161.

Recording medium access unit 170 has a function of reading mail management program 177 from a recording medium 175 having mail management program 177 recorded thereon. Mail management program 177 recorded on recording medium 175 is read from recording medium access unit 170 by the operation (install process) of control unit 112 and stored in storage unit 140.

Recording medium 175 may be a DVD-ROM (Digital Versatile Disk Read Only Memory), a CD-ROM (Compact Disk Read Only Memory), an MO (Magneto Optical Disk), a floppy (registered trademark) disk, a CF (Compact Flash) card, an SM (Smart Media (registered trademark)), an MMC (Multi Media Card), an SD (Secure Digital) memory card, a memory stick (registered trademark), an xD picture card, an USB memory or any other non-volatile memory. Specifically, mail management program 177 and mail management programs 177A and 177B that will be described later are distributed as program products recorded on a medium.

Communication unit 130 performs data communication with control unit 112. Further, communication unit 130 performs wired or wireless data communication with communication unit 135. Communication unit 130 is a communication interface utilizing Ethernet (Registered Trademark).

Further, communication unit 130 may be any communication interface that performs data communication utilizing wired or wireless LAN technique, such as IEEE 802.11a, IEEE802.11b or IEEE802.11g as a wireless LAN standard.

Further, communication unit 130 may be any communication interface that performs serial transfer such as USB (Universal Serial Bus) 1.1 or USB 2.0. Alternatively, communication unit 130 may be any communication interface that performs parallel transfer such as centronics specification or IEEE 1284 (Institute of Electrical and Electronic Engineers 1284). Alternatively, communication unit 130 may be any communication interface adopting IEEE 1394 or other SCSI standard.

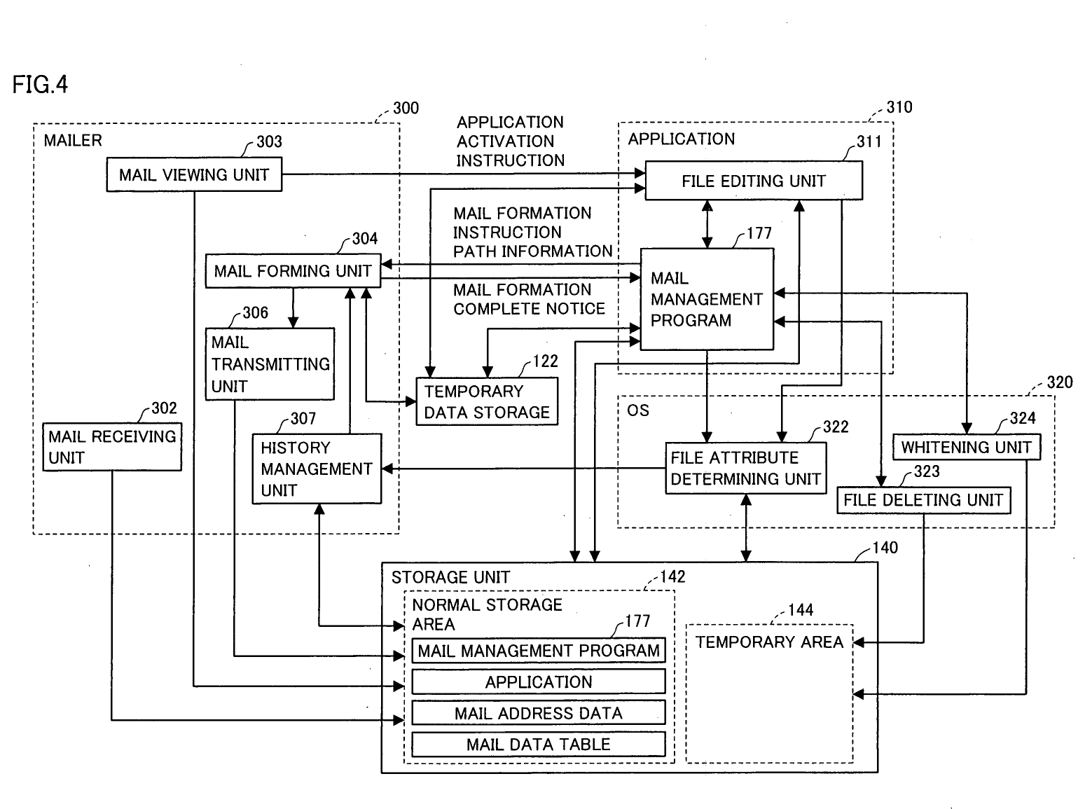

FIG. 4 is a functional block diagram representing mutual relations among a plurality of software programs activated by control unit 112. For easier description, storage unit 140 and temporary data storage 122 are also shown in FIG. 4.

Referring to FIG. 4, in the present embodiment, software programs that are operated by control unit 112 include a mailer 300 that is an e-mail program, an application program 310 and an OS (Operating System) 320. Mailer 300, application program 310 and OS 320 are read from storage unit 140 and activated by control unit 112. It is noted that mailer 300 and application program 310 are software programs operating on OS 320.

In the present embodiment, it is assumed that mailer 300 is Output Express (registered trademark). When a file-attached e-mail is formed, Outlook Express (registered trademark) converts the file in accordance with MIME (Multipurpose Internet Mail Extensions) format, and incorporates the converted file into the e-mail. Therefore, at the time when the file-attached e-mail has been formed by Outlook Express (registered trademark), the original file may be deleted.

In the present embodiment, mailer 300 is not limited to Outlook Express (registered trademark), and any mailer, which has the function that when a file-attached e-mail is formed, the file is converted in accordance with a prescribed format (for example, MIME format) and the converted file is incorporated into the e-mail, may be used.

By way of example, application program 310 is assumed to be Microsoft (registered trademark) Excel. In the present embodiment, mail management program 177 is a plug-in type program that operates incorporated into application program 310 (for example, Microsoft (registered trademark) Excel). Therefore, mail management program 177 has a module that is incorporated in application program 310 and operates as a plug-in. In the present embodiment, application program 310 is not limited to Microsoft (registered trademark) Excel. By way of example, application program 310 may be Microsoft (registered trademark) Word.

OS 320 is assumed to be the next version of Windows (registered trademark) known by the code name “Longhorn”. “Longhorn” is the next version of Windows (registered trademark) OS that follows Windows (registered trademark) XP. “Longhorn” includes a file storage system having the code name “WinFS”.

“WinFS” stores information as to which e-mail is the source that had the file originally attached, as regards a file of a file-attached e-mail. The present embodiment utilizes this function of “WinFS”.

It is noted that OS 320 is not limited to the next version of Windows (registered trademark) called by the code name “Longhorn”. Any other OS may be used as OS 320 that has the function similar to that of the file storage system of “WinFS”.

Storage unit 140 includes a normal storage area 142 storing data and a temporary area 144. Temporary area 144 temporarily stores data, and the data is deleted later. Here, temporary area 144 is that storage area of storage unit 140 which is set by OS 320 as a temporary folder.

Mailer 300 includes a mail receiving unit 302 and a mail viewing unit 303.

Mail receiving unit 302 performs an e-mail receiving process. The e-mail received by mail receiving unit 302 is stored as mail data in normal storage area 142 of storage unit 140. In the following, a plurality of mail data stored in normal storage area 142 of storage unit 140 will be referred to as mail data table.

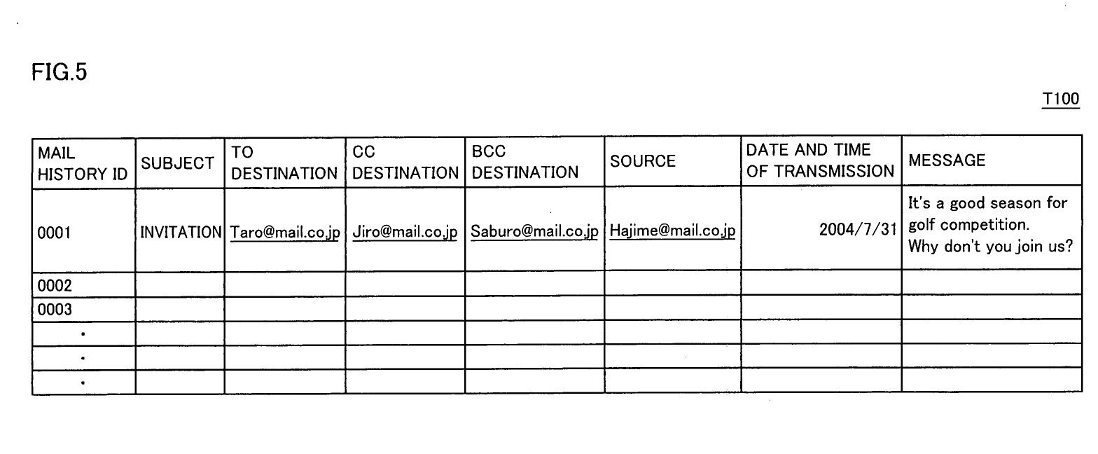

Referring to FIG. 5, in mail data table T100, a mail history ID, subject, TO destination, CC (carbon copy) destination, BCC (blind carbon copy) destination, source, date and time of mailing and main message of the mail are contained, in correspondence to each of the plurality of mail data.

Mail history ID represents an identification information for identifying the e-mail.

Again referring to FIG. 4, mail viewing unit 303 reads data of the e-mail stored in normal storage area 142 of storage unit 140, and generates an image displaying the contents of the e-mail.

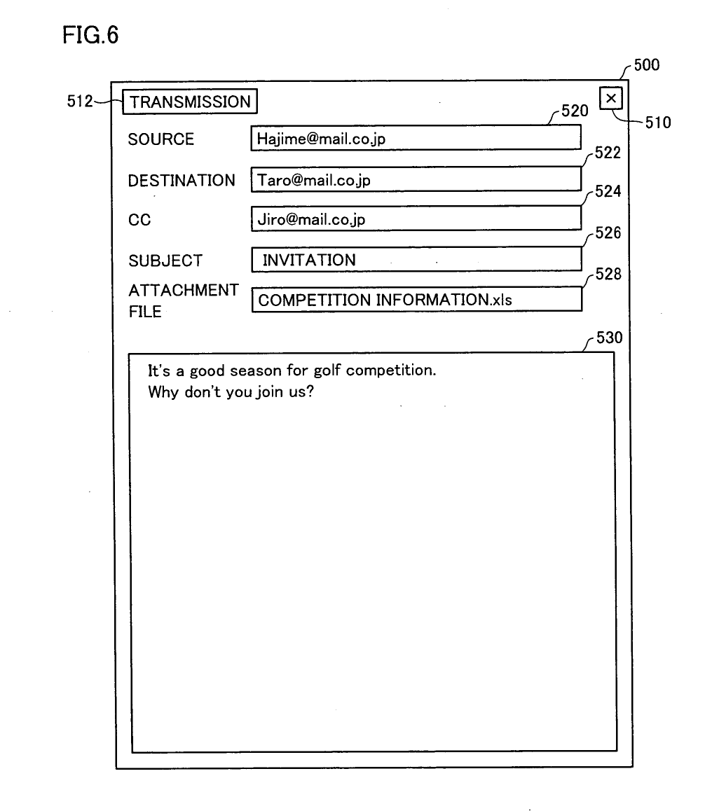

FIG. 6 shows the image 500 displaying the contents of the e-mail. Image 500 displaying the contents of the e-mail appears as a window on display unit 80.

Referring to FIG. 6, image 500 displaying the contents of the e-mail has a display box 520 indicating the source of the e-mail, a display box 522 indicating a destination of the e-mail, a display box 524 indicating CC (carbon copy), a display box 526 indicating a subject, a display box 528 indicating a name of an attached file, and a display box 530 indicating the main message of the e-mail.

Image 500 displaying the contents of the e-mail further has a button 510 for closing the window (image 500 displaying the contents of the e-mail), and a button 512 for transmitting the e-mail having the contents displayed on image 500 to e-mail addresses input to display boxes 522 and 524.

Display boxes 522 and 524 are set to a state that allows character input (hereinafter referred to as a character input possible state), by a single-click of mouse 162 by a user. When either of display boxes 522 and 524 is set to the character input possible state, the user can input desired characters or numbers using keyboard 164.

When the attached file name (Competition information.xls) on display box 528 is double-clicked by the user using mouse 162 (hereinafter, this will also be referred to as edition instruction), application program 310 (Microsoft (registered trademark) Excel) for editing the attached file is activated.

Again referring to FIG. 4, at this time, an application activating instruction for activating application program 310 for editing an attachment file is transmitted from mail viewing unit 303 to application program 310. In response to the application activating instruction, application program 310 is activated to a state that allows edition of the attachment file.

Application program 310 includes a file editing unit 311, and a mail management program 177 as a plug-in of application program 310.

File editing unit 311 performs the process of editing a file. The edited file (hereinafter also referred to as edited data) is stored in storage unit 140, by the process of file editing unit 311.

Mail management program 177 makes a data-access to temporary data storage 122 and to storage unit 140.

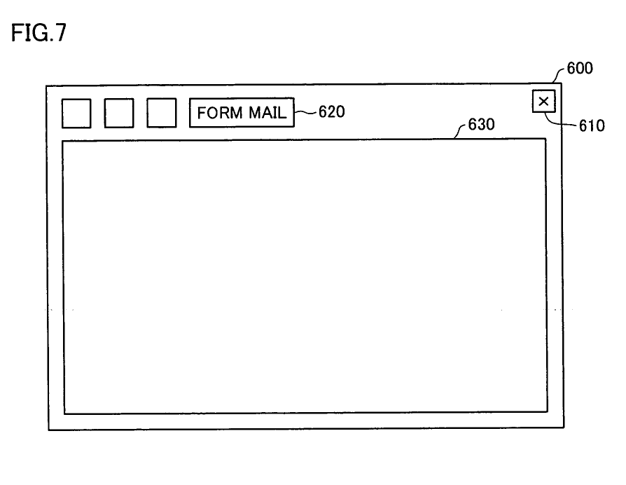

FIG. 7 shows an application program image 600 of application program 310 that is activated. Application program image 600 appears as a window on display 80.

Referring to FIG. 7, application program image 600 has a button 620 for forming an e-mail to which the file that is being edited is attached, a file edition image 630 that is a portion for editing the file in application program 310, and a button 610 for closing the window (application program image 600).

Button 620 is displayed by mail management program 177 as a plug-in.

Again referring to FIG. 4, OS 320 includes a file attribute determining unit 322, a file deleting unit 323 and a whitening unit 324.

File attribute determining unit 322, file deleting unit 323 and whitening unit 324 in the present embodiment operate in the “WinpS” file storage system mentioned above.

By way of example, file attribute determining unit 322 is capable of determining to which e-mail the file that is being edited by application program 310 was attached.

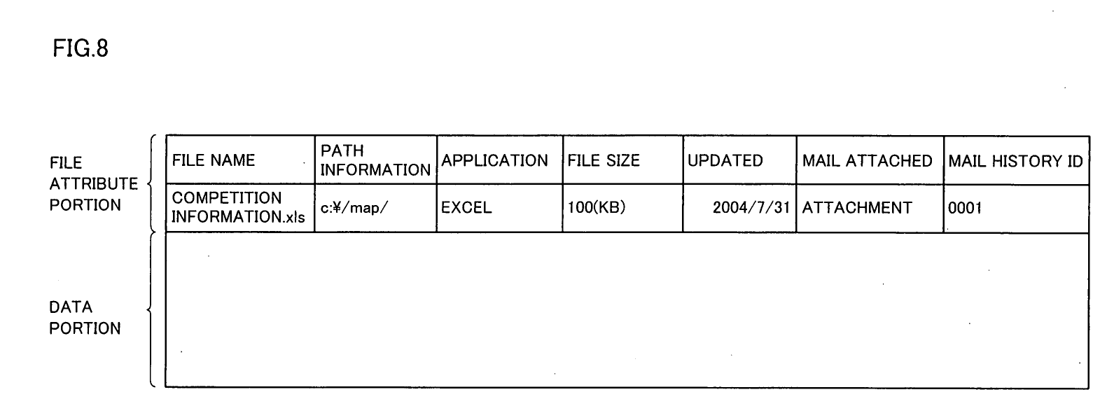

FIG. 8 shows an exemplary configuration of a file used in the present embodiment. The file shown in FIG. 8 is a file that was attached to an e-mail.

Referring to FIG. 8, a file handled by the “WinFS” file storage system consists, by way of example, of a file attribute portion and a data portion.

The file attribute portion includes a file name, path information, application information, file size, updated time, mail attachment information, mail history ID and so on.

Path information is to specify a location where the attachment file is stored. The application information is related to the application by which the file was formed. The mail history ID is for specifying the e-mail to which the file had been attached.

Again referring to FIG. 4, file attribute determining unit 322 is capable of determining to which e-mail the file of interest was attached, from the file having a configuration such as shown in FIG. 8.

File deleting unit 323 deletes the data stored in temporary area 144 of storage unit 140.

Whitening unit 324 performs a whitening process that fully prevents recovery of the data deleted by file deleting unit 323, in temporary area 144 of storage unit 140.

Mailer 300 further includes a mail forming unit 304, a mail transmitting unit 306 and a history managing unit 307.

Mail forming unit 304 forms a mail in response to a mail formation instruction from mail management program 177. When a mail is formed, mail forming unit 304 passes a mail formation complete notice notifying completion of mail formation to mail management program 177.

Mail transmitting unit 306 performs a process for transmitting the e-mail.

History managing unit 307 manages the mail data table that is stored in normal storage area 142 of storage unit 140.

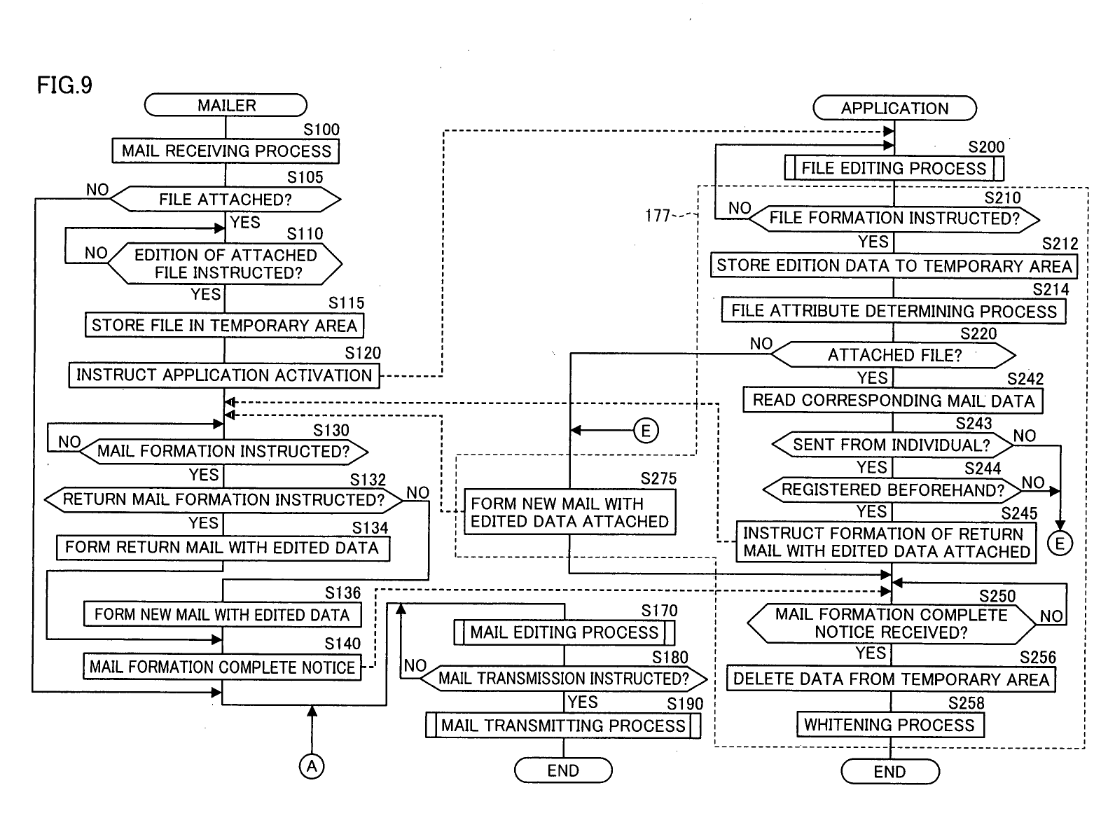

FIG. 9 is a flow chart representing processes executed by mailer 300 and application program 310 in accordance with the present embodiment.

The processes of steps S210, S212, S214, S220, S242, S243, S244, S245, S250, S256, S258 and S275 are performed by mail management program 177 incorporated as a plug-in to application program 310.

Next, referring to FIGS. 2, 4, 7 and 9, the processes executed by mailer 300 and application program 310 in accordance with the present embodiment will be described.

In step S100, mail receiving unit 302 performs an e-mail receiving process. The e-mail received by mail receiving unit 302 is stored as mail data in normal storage area 142 of storage unit 140. Thereafter, the process of step S105 takes place.

In step S105, whether the received e-mail has an attachment file or not is determined. If it is determined in step S105 that the received e-mail has an attachment file, the flow proceeds to step S110. If it is determined in step S105 that the received e-mail does not have any attachment file, the flow proceeds to step S170, which will be described later.

In step S110, whether the above-described edition instruction for editing the attachment file has been issued or not is determined. If it is determined in S110 that there is the edition instruction, the flow proceeds to step S115. If it is determined in S110 that there is no edition instruction, the process of step S110 is repeated.

In step S115, mail viewing unit 303 has the attachment file stored in temporary area 144 of storage unit 140. Thereafter, the flow proceeds to step S120.

In step S120, mail viewing unit 303 transmits an application activation instruction to application program 310 for editing the attachment file that has been stored in temporary area 144. In response to the application activation instruction, application program 310 reads the attachment file, and is activated to a state that allows edition of the attachment file.

In application program 310, first, the process of step S200 is performed.

Step S200 is a file editing process.

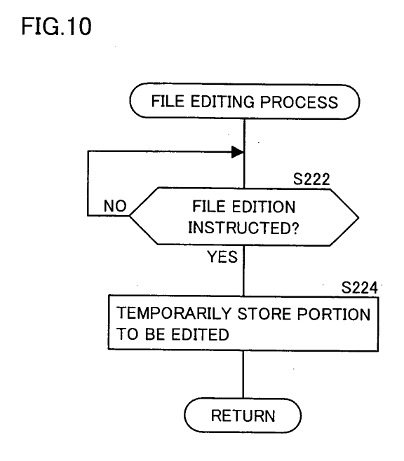

FIG. 10 is a flow chart representing the file editing process.

Referring to FIG. 10, in step S222, whether there is a file edition instruction or not is determined. By way of example, when the user edits a part of file editing image 630 using mouse 162 and keyboard 164, application program 310 receives a file edition instruction from file editing unit 311. Application program 310 determines that there is a file edition instruction, upon reception of the file edition instruction.

If it is determined in step S222 that there is a file edition instruction, the flow proceeds to step S224. If it is determined in step S222 that there is not a file edition instruction, the process of step S222 is repeated.

In step S224, file editing unit 311 has the data of the edited portion of the file (hereinafter also referred to as an edited portion data) in temporary data storage 122. Then, the file editing process ends and the control returns to the main flow.

Again referring to FIG. 9 when the process of step S200 ends, the flow proceeds to step S210.

In step S210, whether there is a mail formation instruction or not is determined. Specifically, whether the user has single-clicked the button 620 arranged on application program image 600 of FIG. 7 by mouse 162 or not is determined.

If it is determined in step S210 that the user has single-clicked button 620 by mouse 162, the flow proceeds to the process of step S212. If it is determined in step S210 that the user has not single-clicked button 620 by mouse 162, the process of step S200 is repeated.

In step S212, the edition data at the time the user single-clicked button 620 by mouse 162 is stored in temporary area 144. Specifically, the edited portion data stored in temporary data storage 122 is read by mail management program 177, and mail management program 177 has the edition data based on the edited portion data stored in temporary area 144.

If data before edition has been stored in temporary area 144 by the process of step S115, the data before edition is deleted, and the edited data is stored. Namely, the data is rewritten and stored. Thereafter, the process of step S214 starts.

In step S214, a file attribute determining process is performed. In the file attribute determining process, file editing unit 311 causes file attribute determining unit 322 to determine whether the file stored in temporary area 144 in step S212 (in the following, also referred to as a temporarily stored file) was attached to an e-mail or not.

In the file attribute determining process, if it is determined that the temporarily stored file was attached to an e-mail, file editing unit 311 causes file attribute determining unit 322 to determine to which e-mail the temporarily stored file was attached. Thereafter, the process of step S220 is performed.

If it is determined in step S220 that the temporarily stored file was attached to an e-mail based on the process of step S214, the flow proceeds to step S242. If it is determined from the process of step S214 that the temporarily stored file was not attached to an e-mail, the flow proceeds to step S275, which will be described later.

In step S242, mail management program 177 reads the mail data of the e-mail (by way of example, the data of the row having mail history ID of “0001” in mail data table T100 shown in FIG. 5) determined by file attribute determining process of step S214, from normal storage area 142 of storage unit 140. Thereafter, the process of step S243 is performed.

In step S243, whether the source of the e-mail is an individual or not is determined, based on the mail data read in step S242. This is to prevent formation of a return mail to a mail directly sent from an MFP (such as a mail having a scanned original image attached thereto).

If it is determined in step S243 that the source of the e-mail is an individual, the flow proceeds to step S244. If it is determined in step S243 that the source of the e-mail is not an individual (for example, MFP), the flow proceeds to step S275, which will be described later.

In step S244, based on the mail data read in step S242, whether the source of the e-mail has been registered in advance (listed in the mail address data of FIG. 3) or not is determined. This is to automatically form a return mail not to all the e-mails from individuals but only to persons to whom return mails are frequently sent.

If it is determined in step S244 that the source of the e-mail has been registered in advance, the flow proceeds to step S245. If it is determined in step S244 that the source of the e-mail has not been registered in advance, the flow proceeds to step S275, which will be described later. In step S275, an instruction is given to form a new mail having the edited data attached thereto, of which details will be described later.

In the present embodiment, at least one of steps S243 and S244 may be omitted.

In step S245, mail management program 177 passes an instruction to form a return mail with the edited data attached, to mailer 300. At the same time, mail management program 177 also passes path information for specifying the location where the edited data is stored and the information related to the source of the e-mail, to mailer 300.

The process in which mailer 300 determines whether the instruction to form a return mail has been given by mail management program 177 or not is performed in steps S130 and S132.

The process of step S130 is performed after the process of step S120 described above.

In step S130, whether an instruction to form a mail has been received from mail management program 177 or not is determined. If it is determined in step S130 that there is a mail formation instruction, the flow proceeds to step S132. If it is determined in step S130 that there is not a mail formation instruction, the process of step S130 is repeated.

In step S132, whether the mail formation instruction received by mailer 300 is a return mail formation instruction or not is determined. If it is determined in step S132 that the instruction is the return mail formation instruction, the flow proceeds to step S134. If it is determined in step S132 that the instruction is not a return mail formation instruction, the flow proceeds to step S136, which will be described later.

In step S134, mail forming unit 304 reads the edited data from temporary area 144 of storage unit 140, based on the path information. Mail forming unit 304 forms a return mail having the read edited data attached thereto (hereinafter also referred to as a edited-data-attached e-mail), based on the information of the source received from mail management program 177. Thereafter, the flow proceeds to step S140.

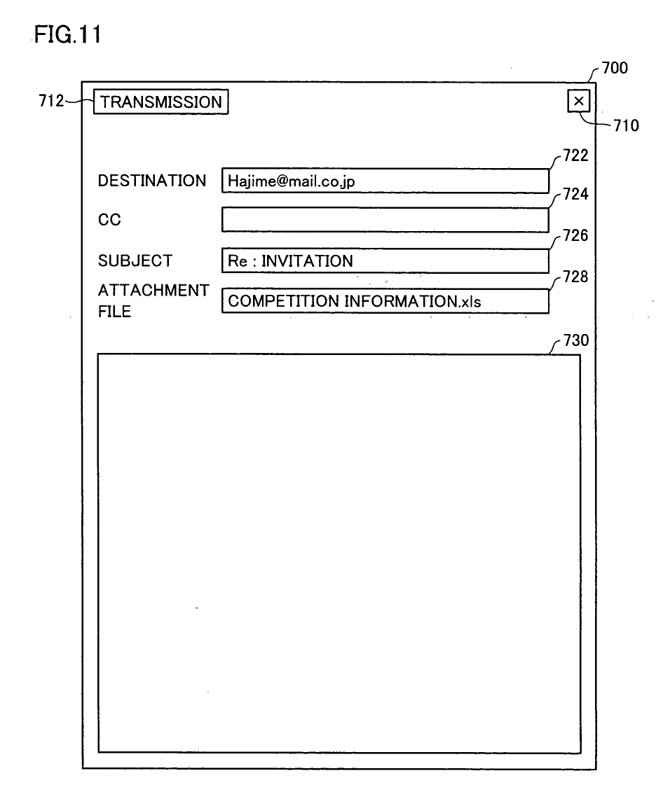

FIG. 11 is an image representing a return mail 700. The return mail image 700 appears as a window on display unit 80.

Referring to FIG. 11, return mail image 700 is different from e-mail contents display image 500 in that it does not includes display box 520, display box 522 is replaced by input box 722, display box 524 is replaced by input box 724, display box 526 is replaced by input box 726, display box 528 is replaced by input box 728, and display box 530 is replaced by input box 730.

Further, return mail image 700 is different from e-mail contents display image 500 in that button 510 is replaced by button 710 and button 512 is replaced by button 712. Except for these points, it is the same as e-mail contents display image 500, and therefore, detailed description will not be repeated.

Input box 722 is for inputting the destination of the e-mail. Input box 724 is for inputting CC (carbon copy). Input box 726 is for inputting the subject. Input box 728 indicates the file name of the edited data, that is, the attachment file. Input box 730 is for inputting messages.

Button 710 is for closing the window (return mail image 700). Button 712 is for transmitting the e-mail having the contents displayed on return mail image 700 to the e-mail addresses input to boxes 722 and 724.

When a return mail to the mail shown in e-mail contents display image 500 is to be formed, for instance, the mail address of the source of e-mail contents display image 500 is automatically input to input box 722.

Input boxes 722, 724, 726 and 730 are set to a state that allows character input (hereinafter referred to as a character input possible state), by a single-click of mouse 162 by a user. When any of input boxes 722, 724, 726 and 730 is set to the character input possible state, the user can input desired characters or numbers using keyboard 164.

Again referring to FIG. 9, in step S140, a mail formation complete notice notifying that the mail has been formed, is passed to mail management program 177.

The process in which mail management program 177 determines whether the mail formation complete notice is received from mailer 300 or not is performed in step S250.

The process of step S250 is performed after the process of step S245 described above.

In step S250, whether the mail formation complete notice is received from mailer 300 or not is determined. If it is determined in step S250 that the mail formation complete notice is received, the flow proceeds to step S256. If it is determined in step S250 that the mail formation complete notice is not received from mailer 300, the process of step S250 is repeated.

In step S256, the edited data stored in temporary area 144 is deleted. Specifically, mail management program 177 issues a deletion instruction to file deleting unit 323 to delete the edited data stored in temporary area 144. In response to the deletion instruction, file deleting unit 323 deletes the edited data stored in temporary area 144. Thereafter, the process of step S258 is performed.

If it is necessary to save the edition data in normal storage area 142, a process may be performed between the steps S250 and S256 in which the edition data stored in temporary area 144 is replicated in normal storage area 142.

In step S258, the whitening process is performed. Specifically, mail management program 177 instructs whitening unit 324 to perform whitening, so as to fully prevent recovery of the edition data that has been deleted in step S256 in temporary area 144. Whitening unit 324 performs the whitening process to fully prevent recovery of the deleted edition data, in response to the whitening instruction. Then, the process of application program 310 ends.

Following the process of step S 140, mailer 300 performs the process of step S170.

In step S170, a mail editing process is performed.

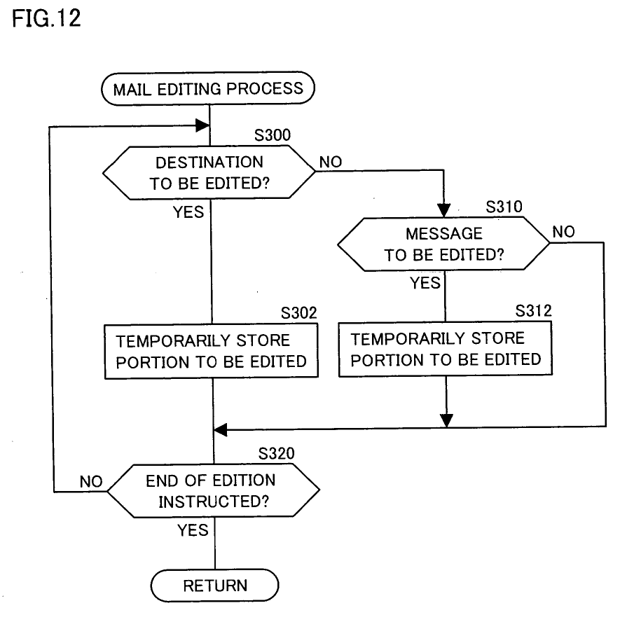

FIG. 12 is a flow chart representing the mail editing process.

Referring to FIG. 12, in step S300, whether there is an edition in destination or not is determined. Specifically, whether any of the input boxes 722 and 724 of return mail image 700 shown in FIG. 11 has been edited by the user through mouse 162 and keyboard 164 or not is determined.

If it is determined in step S300 that there is an edition in destination, the process of step S302 is performed. If it is determined in step S300 that there is not an edition in destination, the process of step S310, which will be described later, is performed.

In step S302, mail forming unit 304 has data with its destination edited (hereinafter also referred to as destination-edited data) stored in temporary data storage 122. Thereafter, the flow proceeds to step S320.

In step S320, whether there is an edition end instruction or not is determined. Specifically, whether the user has single-clicked button 710 on return mail image 700 by mouse 162 or not is determined.

If it is determined in step S320 that the user has single-clicked button 710 on return mail image 700 by mouse 162, the window (return mail image 700) is closed (deleted). Then, the mail editing process ends and the control returns to the main flow. If it is determined in step S320 that the user has not single-clicked button 710 on return mail image 700 by mouse 162, the process of step S300 is repeated.

If it is determined in step S300 that there is not an edition in destination, the process of step S310 is performed.

In step S310, whether there is an edition in message or not is determined. Specifically, whether the user has input or edited a message of input box 730 of return mail image 700 shown in FIG. 11 by mouse 162 and keyboard 164 or not is determined.

If it is determined in step S310 that there is an edition in message, the flow proceeds to step S312. If it is determined in step S310 that there is not an edition in message, the process of step S320 described above is performed.

In step S312, mail forming unit 304 has data of the message input to input box 730 (hereinafter also referred to as message data) stored in temporary data storage 122. Thereafter, the process of step S320 described above is performed.

Again referring to FIG. 9, when the process of step S170 ends, the flow proceeds to step S180.

In step S180, whether there is a mail transmission instruction or not is determined. Specifically, whether the user has single-clicked button 712 on return mail image 700 by mouse 162 or not is determined.

If it is determined in step S 180 that the user has single-clicked button 712 by mouse 162, the process of step S 190 is performed. If it is determined in step S180 that the user has not single-clicked button 712 by mouse 162, the process of step S170 is repeated.

In step S190, a mail transmission process is performed.

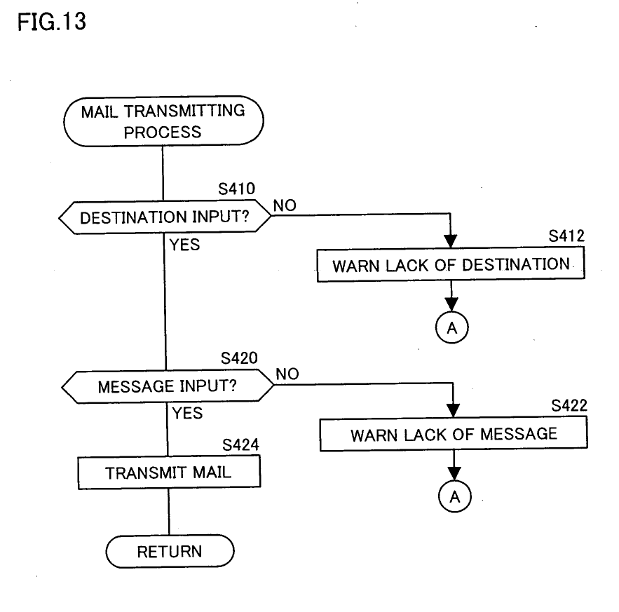

FIG. 13 is a flow chart representing the mail transmission process.

Referring to FIG. 13, in step S410, whether a destination has been input to input box 722 or not is determined. If it is determined in step S410 that the destination has been input to input box 722, the flow proceeds to step S420. If it is determined in step S410 that the destination has not been input to input box 722, the flow proceeds to step S412.

In step S412, a dialog indicating lack of destination is displayed on display unit 80, as a warning to the user. Thereafter, the process of step S170 is repeated.

In step S420, whether a message has been input to input box 730 or not is determined. If it is determined in step S420 that a message has been input to input box 730, the process of step S424 is performed. If it is determined in step S420 that no message has been input to input box 730, the process of step S422 is performed.

In step S422, a dialog indicating that no message has been input is displayed on display unit 80, as a warning to the user. Thereafter, the process of step S170 is repeated.

In step S424, mail transmitting unit 306 transmits an e-mail having the contents shown on return mail image 700 to the e-mail address or addresses input to input box 722 and 724. Thus, the mail transmitting process ends and the control returns to the main flow.

Then, the process of mailer 300 ends.

As described above, in the present embodiment, a file that has been attached to a received e-mail can be edited and an edited-data-attached e-mail as a return mail can be formed through a simple operation.

As the edition data attached to the edited-data-attached e-mail is automatically deleted, hard disk capacity is not wasted. As a result, storage area of the hard disk can effectively be used. Further, as the edition data is deleted automatically, troublesome operation by the user to delete the edition data becomes unnecessary.

Even if the edition data is confidential and unnecessary, whitening process is performed to fully prevent recovery of the edition data, and therefore, possibility of leakage of the confidential data is minimized.

In the foregoing, a process for editing a file that has been attached to an e-mail and for forming an e-mail with the edited file attached has been described.

Next, formation of an edited-file-attached e-mail having a file newly formed by application program 310 attached thereto, or an edited-file-attached e-mail having a file that has been formed previously and edited by application program 310 attached thereto will be described. It is assumed that application program 310 has been activated.

Referring to FIGS. 2, 4, 6 and 9, by application program 310, processes of steps S200, S210, S212, S214 and S220 as described above are performed.

If it is determined in step S220 that a temporary storage file is not attached to an e-mail, the flow proceeds to step S275. Here, it is the case that application program 310 is forming a new file, or application program 310 has read a file formed previously from storage unit 140 and is editing the file.

In step S275, mail management program 177 passes an instruction to mailer 300 to form a new mail with edited file attached thereto. At the same time, mail management program 177 also passes path information for specifying the location where the edition data is stored, to mailer 300.

The process in which mailer 300 determines whether the instruction to form a new mail has been received from mail management program 177 or not is performed in steps S130 and S132 described above.

In step S130, whether a mail formation instruction has been received from mail management program 177 or not is determined. If it is determined in step S130 that the mail formation instruction has been received, the flow proceeds to step S132. If it is determined in step S130 that the mail formation instruction has not been received, the process of step S130 is repeated.

In step S132, whether the mail formation instruction received by mailer 300 is an instruction to form a return mail or not is determined. If it is determined in step S132 that the mail formation instruction is not to form a return mail, that is, the instruction is to form a new mail, the flow proceeds to step S136.

In step S136, mail forming unit 304 reads edition data from temporary area 144 based on the received path information. Mail forming unit 304 forms a new mail with the read edition data attached (hereinafter also referred to as edited-data-attached new mail). Then, the flow proceeds to step S140 that has been described above.

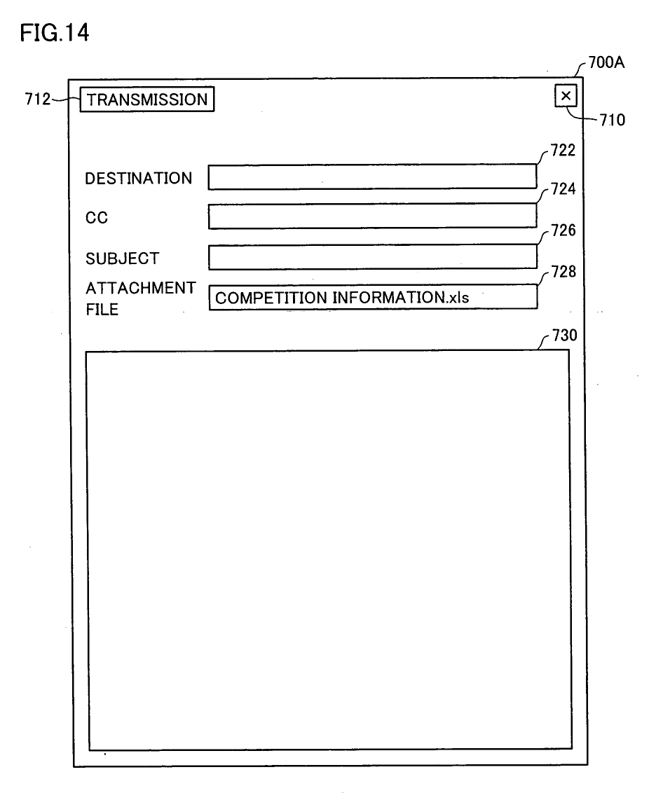

FIG. 14 is an image 700A showing a new mail. New mail image 700A appears as a window on display unit 80.

Referring to FIG. 14, new mail image 700A is different from return mail image 700 of FIG. 11 in that nothing is described in input boxes 722 and 726. Except for these points, the image is the same as return mail image 700, and therefore, detailed description thereof will not be repeated.

Again referring to FIG. 9, in step S140, a mail formation complete notice indicating completion of mail formation is passed to mail management program 177.

The process in which mail management program 177 determines whether the mail formation complete notice has been received from mailer 300 or not is performed in step S250 described above.

After the process of step S250, steps S256, S258, S170, S180 and S190 follow. Then, the process by mailer 300 ends.

In the present embodiment, the processes of steps S256 and S258 described above may be performed not by the application program but by the mailer.

Through the above-described process, it becomes possible to prepare an edited-file-attached e-mail having a file newly formed by application program 310 attached thereto, or an edited-file-attached e-mail having a file that has been formed previously and edited by application program 310 attached thereto. In this case also, effects similar to those attained by the process of forming a return mail by editing a file that has been attached to a received mail can be attained.

### Second Embodiment

In the first embodiment, formation of an e-mail when the OS is Windows (registered trademark) referred to as “Longhorn” having “WinFS” has been described. In the present embodiment, it is assumed that the OS is one that does not have “WinFS”, such as Windows (registered trademark) XP.

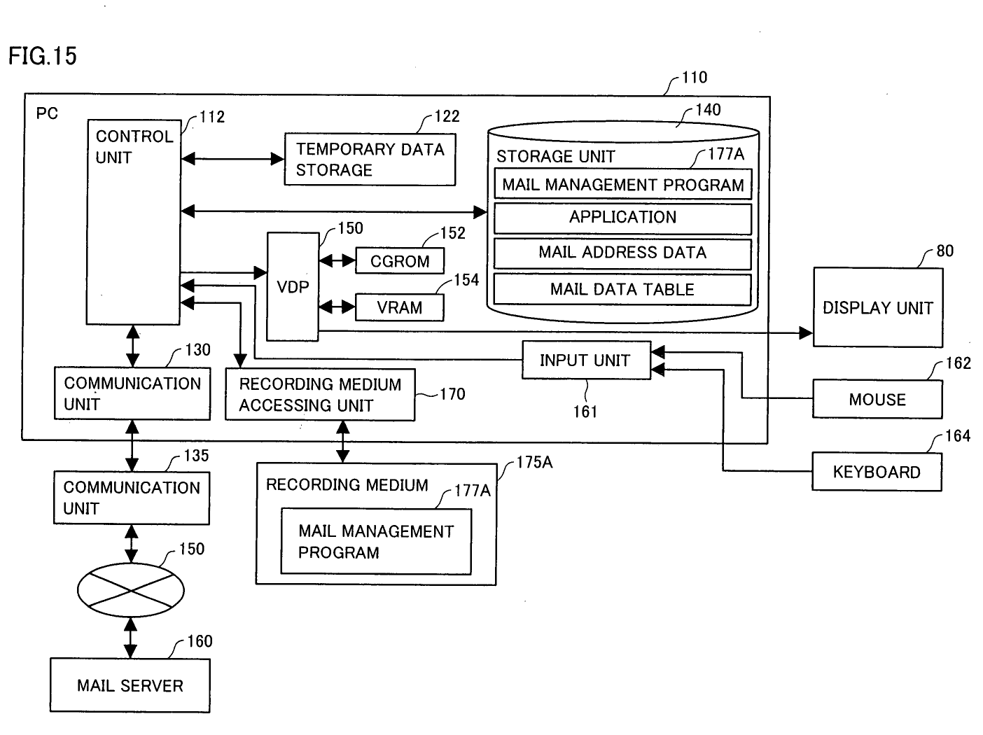

FIG. 15 is a block diagram showing an internal configuration of a PC 110 in accordance with the second embodiment. For easier description, a communication unit 135, a network 150, a mail server 160 and a recording medium 175A are also shown in FIG. 15.

Referring to FIG. 15, the configuration of PC 110 of the second embodiment differs from that of PC 110 of the first embodiment in that storage unit 140 stores a mail management program 177A in place of mail management program 177, and that recording medium accessing unit 170 accesses to recording medium 175A in place of recording medium 175. Recording medium 175A is different from recording medium 175 in that it stores mail management program 177A in place of mail management program 177.

Mail management program 177A stored in recording medium 175A is read by the operation of control unit 112 (install process) through recording medium accessing unit 170 and stored in storage unit 140.

Other configuration is the same as that of PC 110 in accordance with the first embodiment, and therefore, detailed description will not be repeated.

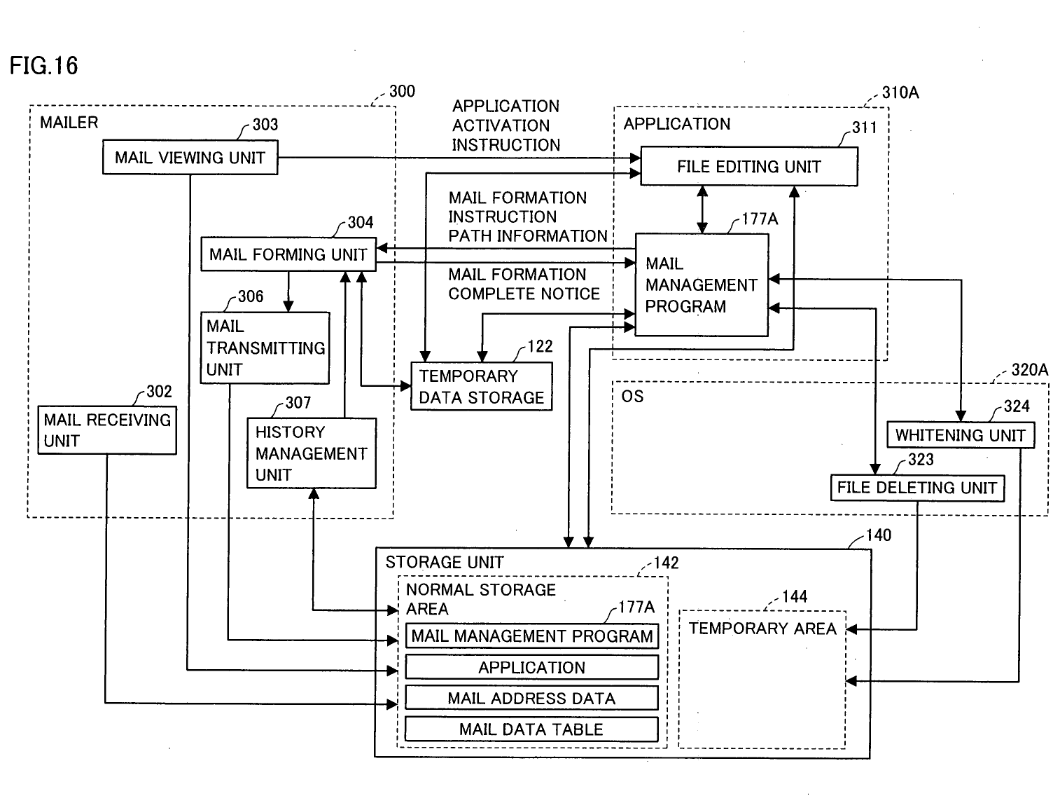

FIG. 16 is a functional block diagram representing mutual relation among a plurality of software programs activated by control unit 112, in accordance with the second embodiment. For description, storage unit 140 and temporary data storage 122 are also shown in FIG. 16.

Referring to FIG. 16, the software configuration of the second embodiment is different from the software configuration of the first embodiment in that application program 310A is used in place of application program 310, and that OS 320A is used in place of OS 320.

Application program 310A differs from application program 310 in that it contains mail management program 177A as a plug-in, in place of mail management program 177. Mail management program 177A has a module incorporated in application program 310 to operate as a plug-in.

OS 320A is assumed to be one not having “WinFS”, such as Windows (registered trademark) XP. In the present embodiment, OS 320A is not limited to Windows (registered trademark) XP, and it may be any OS not having “WinFS”, such as Windows (registered trademark) 98.

Other software configuration is the same as that of the first embodiment, and therefore, detailed description will not be repeated.

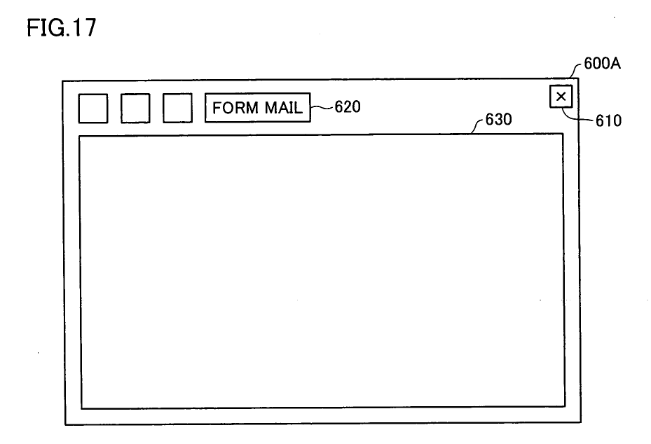

FIG. 17 shows an application program image 600A of the activated application program 310A. Application program image 600A appears as a window on display unit 80.

Referring to FIG. 17, application program image 600A is the same as application program image 600, and therefore, detailed description will not be repeated.

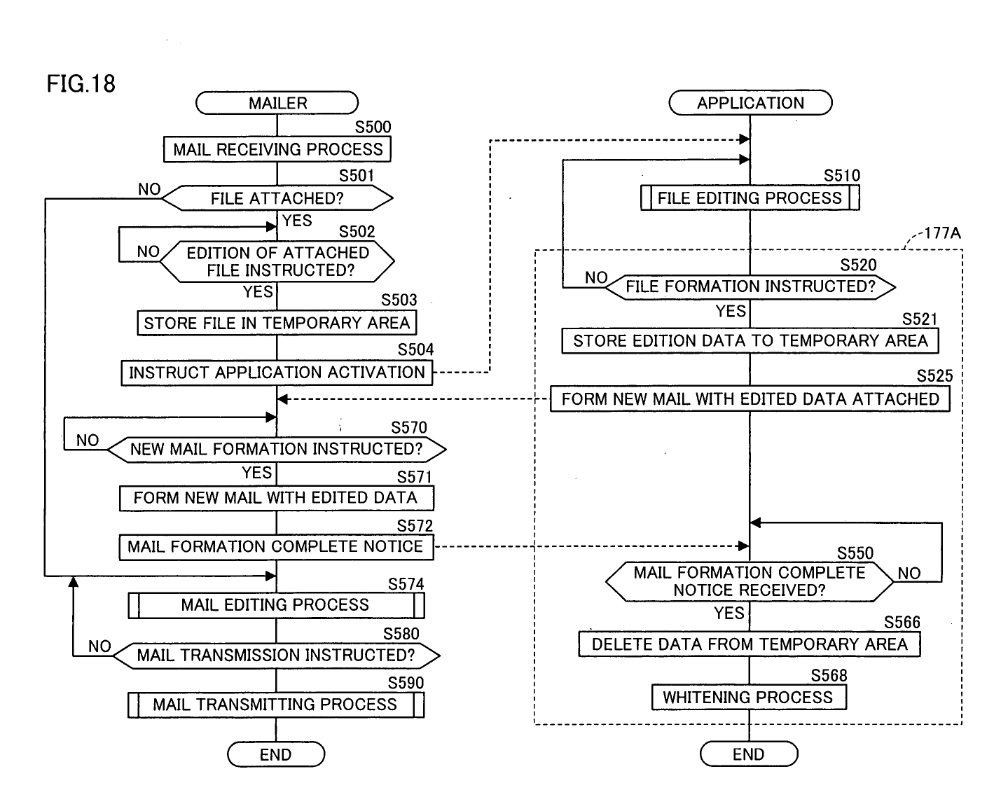

FIG. 18 is a flow chart representing processes executed by mailer 300 and application program 310A in accordance with the second embodiment.

The processes of steps S520, S521, S525, S550, S566 and S568 are executed by mail management program 177A incorporated as a plug-in of application program 310A.

Next, referring to FIGS. 15, 16, 17 and 18, the processes executed by mailer 300 and application program 310A of the present embodiment will be described.

Referring to FIG. 18, the process of step S500 is the same as that of step S100 described above, and therefore, detailed description thereof will not be repeated. Then, the flow proceeds to step S501.

In step S501, whether the received e-mail has an attached file or not is determined. If it is determined in step S501 that the received e-mail has an attachment file, the flow proceeds to step S502. If it is determined in step S501 that the received e-mail does not have any attachment file, the flow proceeds to step S574, which will be described later.

In step S502, whether or not there is an edition instruction to edit the attachment file described above is determined. If it is determined in step S502 that there is an edition instruction, the flow proceeds to step S503. If it is determined in step S502 that there is not an edition instruction, the process of step S502 is repeated.

The process performed in step S503 is the same as that of step S115 described above, and therefore detailed description will not be repeated. After the process of step S503, the flow proceeds to step S504.

In step S504, an application activation instruction is transmitted from mail viewing unit 303 to application program 310A to edit the attachment file stored in temporary area 144. In response to the application activation instruction, application program 310A reads the attachment file, and is activated to a state that allows edition of the attachment file.

Application program 310A first executes the process of step S510.

In step S510, file edition process is performed. The file editing process is the same as that of step S200, and therefore description thereof will not be repeated. Thereafter, the flow proceeds to step S520.

In step S520, whether there is a mail formation instruction or not is determined. Specifically, whether the user single-clicked button 620 on application program image 600A of FIG. 17 by mouse 162 or not is determined.

If it is determined in step S520 that button 620 has been single-clicked by mouse 162, the flow proceeds to step S521. If it is determined in step S520 that the user has not single-clicked button 620 by mouse 162, the process of step S510 is repeated.

In step S521, the process similar to that of step S212 described above is performed, and therefore, detailed description will not be repeated. Then, the flow proceeds to step S525.

In step S525, mail management program 177A passes an instruction to mailer 300 to form a new mail with the edited data attached thereto. At the same time, mail management program 177A also passes path information for specifying the location where the edition data is stored, to mailer 300.

The process in which mailer 300 determines whether an instruction to form a new mail has been received from mail management program 177A or not is performed in step S570. The process of step S570 is performed following the step S504 described above.

In step S570, whether an instruction to form a new mail has been received from mail management program 177A or not is determined. If it is determined in step S570 that an instruction to form a new mail has been received from mail management program 177A, the flow proceeds to step S571. If it is determined in step S570 that no instruction to form a new mail has been received from mail management program 177A, the process of step S570 is repeated.

In step S571, mail forming unit 304 reads the edition data from temporary area 144 of storage unit 140, based on the received path information. Mail forming unit 304 forms a new mail with the read edition data attached (in the following, also referred to as edited-data-attached new mail). The image of the thus formed new mail is shown, by way of example, as new mail image 700A of FIG. 14. Then, the process of step S572 is performed.

In step S572, a mail formation complete notice indicating completion of mail formation is passed to mail management program 177A.

The process in which mail management program 177A determines whether the mail formation complete notice has been received from mailer 300 or not is performed in step S550.

In step S550, whether the mail formation complete notice has been received from mailer 300 or not is determined. In step 550, if it is determined that the mail formation complete notice has been received from mailer 300, the flow proceeds to step S566. If it is determined that the mail formation complete notice has not been received from mailer 300, the process of step S550 is repeated.

The process performed in step S566 is the same as that of step S256 described above, and therefore, detailed description thereof will not be repeated. After the process of step S566, the flow proceeds to step S568.

The process performed in step S568 is the same as that of step S258 described above, and therefore, detailed description thereof will not be repeated. Thereafter, the process of application program 310A ends.

After the step of S572, mailer 300 performs the process of step S574.

The process performed in step S574 is the same as that of step S170 described above. Therefore, detailed description will not be repeated. After the process of step S574, the flow proceeds to step S580.

In step S580, whether there is a mail transmission instruction or not is determined. Specifically, whether the user has single-clicked, by way of example, button 712 arranged on new mail image 700A of FIG. 14 by mouse 162 or not is determined.

If it is determined in step S580 that the user has single-clicked button 712 arranged on new mail image 700A, the flow proceeds to step S590. If it is determined in step S580 that the user has not single-clicked button 712 arranged on new mail image 700A, the process of step S574 is repeated.

In step S590, the process of step S190 described above is performed, and therefore, detailed description will not be repeated. Then, the process by mailer 300 ends.

In the present embodiment, the processes of steps S566 and S568 may be performed not by the application program but by the mailer.

Through the above-described steps, even by an OS not having “WinFS”, a file that has been attached to a received e-mail can be edited and a new mail having the edited file attached can be formed by a simple operation.

The edition data attached to the edition-data-attached e-mail is automatically deleted, and therefore, hard disk capacity is not wasted. As a result, the storage area of the hard disk can effectively be utilized. Further, as the edition data is automatically deleted, it becomes unnecessary for the user to delete the edition data through troublesome manual operation.

Even if the edition data is confidential and unnecessary, whitening process is performed to fully prevent recovery of the edition data, and therefore, possibility of leakage of the confidential data is minimized.

### Third Embodiment

In the first and second embodiments, the mailer has been described as Outlook Express (registered trademark). Next, the process of automatically deleting the edition data using Eudora (registered trademark) will be described.

In Eudora (registered trademark), at the time when a file-attached e-mail is formed, only the path information of the file to be attached is incorporated in the e-mail. Further, in Eudora (registered trademark), when a file-attached e-mail is received, the file is automatically saved in a prescribed folder. In Eudora (registered trademark), the file to be attached is converted in accordance with the MIME format and the converted file is incorporated with the e-mail at the time when the mail is transmitted.

In the present embodiment, the OS is the same as that described in the second embodiment.

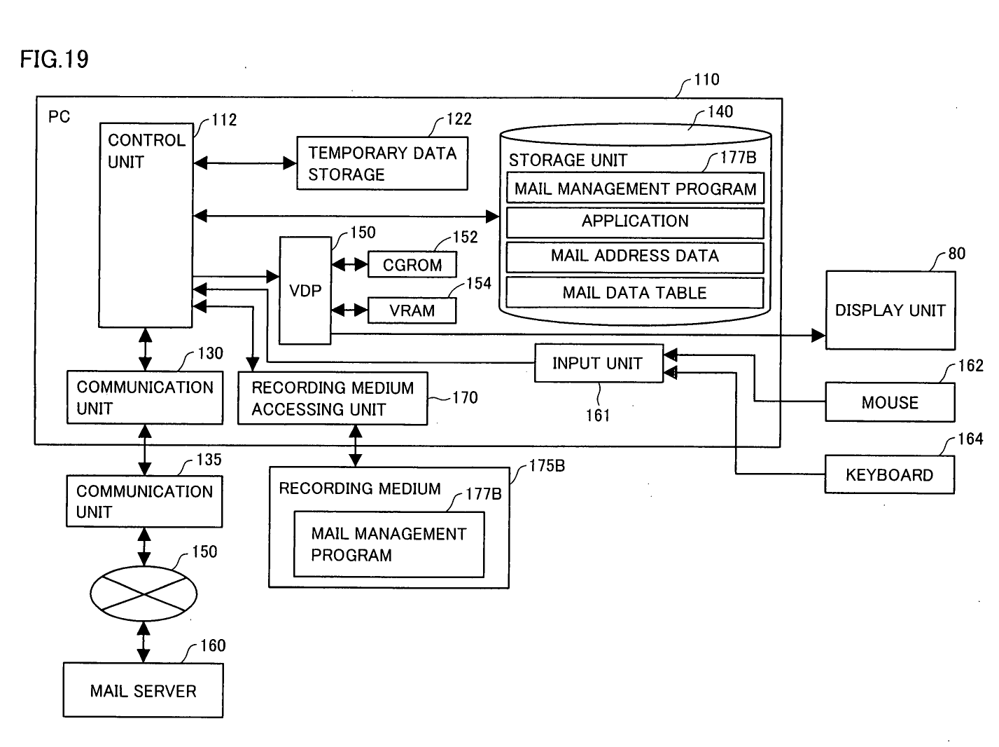

FIG. 19 is a block diagram representing an internal configuration of a PC 110 in accordance with the third embodiment. For easier description, a communication unit 135, a network 150, a mail server 160 and a recording medium 175B are also shown in FIG. 19.

Referring to FIG. 19, the configuration of PC 110 of the third embodiment differs from that of PC 110 in accordance with the first embodiment in that storage unit 140 stores a mail management program 177B in place of mail management program 177, and that recording medium accessing unit 170 accesses to recording medium 175B in place of recording medium 175. Different from recording medium 175, recording medium 175B stores mail management program 177B in place of mail management program 177.

Mail management program 177B stored in recording medium 175B is read by the operation of control unit 112 (install operation) through recording medium accessing unit 170, and stored in storage unit 140.

Except for this point, the configuration is the same as that of PC 110 in accordance with the first embodiment, and therefore, detailed description will not be repeated.

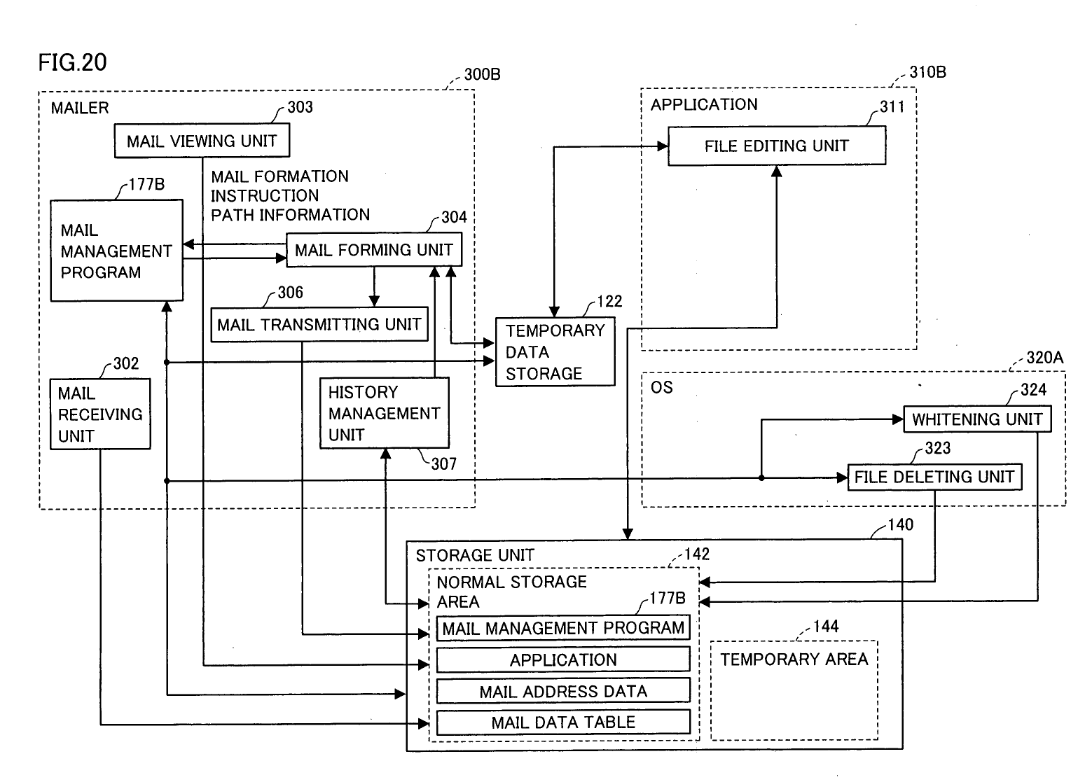

FIG. 20 is a functional block diagram representing mutual relation among a plurality of software programs activated by control unit 112, in accordance with the third embodiment. For easier description, storage unit 140 and temporary data storage 122 are also shown in FIG. 20.

Referring to FIG. 20, the software configuration of the third embodiment is different from the software configuration of the second embodiment in that application program 310B is used in place of application program 310A, and that mailer 300B is used in place of mailer 300.

Application program 310B is different from application program 310A in that mail management program 177A is not incorporated as a plug-in.

Mailer 300B is different from mailer 300 in that mail management program 177B is incorporated as a plug-in. Mail management program 177B has a module that is incorporated in mailer 300B and operates as a plug-in.

In the present embodiment, the mailer 300B is not limited to Eudora (registered trademark), and any mailer may be used that has a function similar to Eudora (registered trademark) described above.

Mail viewing unit 303 does not issue an application activation instruction to file editing unit 311.

File deleting unit 323 deletes data stored in normal storage area 142 of storage unit 140.

Whitening unit 324 performs a whitening process that fully prevents recovery of the data deleted by file deleting unit 323, in normal storage area 142 of storage unit 140.

Except for these points, the software configuration is the same as that of the second embodiment, and therefore, detailed description thereof will not be repeated.

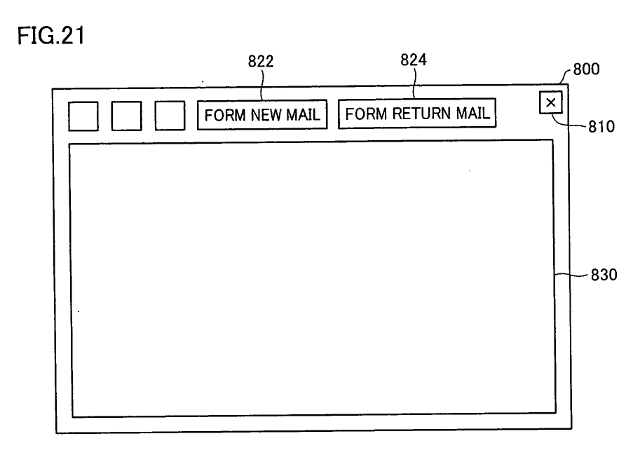

FIG. 21 shows an image 800 of mailer 300B for viewing the received mail, in accordance with the third embodiment. The received mail viewing image 800 appears as a window on display unit 80.

Referring to FIG. 21, received mail viewing image 800 has an image 830 showing a list of received mails, a button 822 for forming a new mail, and a button 824 for forming a return mail.

While a received mail displayed on the received mail list image 830 is selected by the user using mouse 162 (hereinafter also referred to as a mail-selected state), when the user single-clicks button 824 by mouse 162, a return mail is formed.

Received mail viewing image 800 further has a button 810 for closing the window.

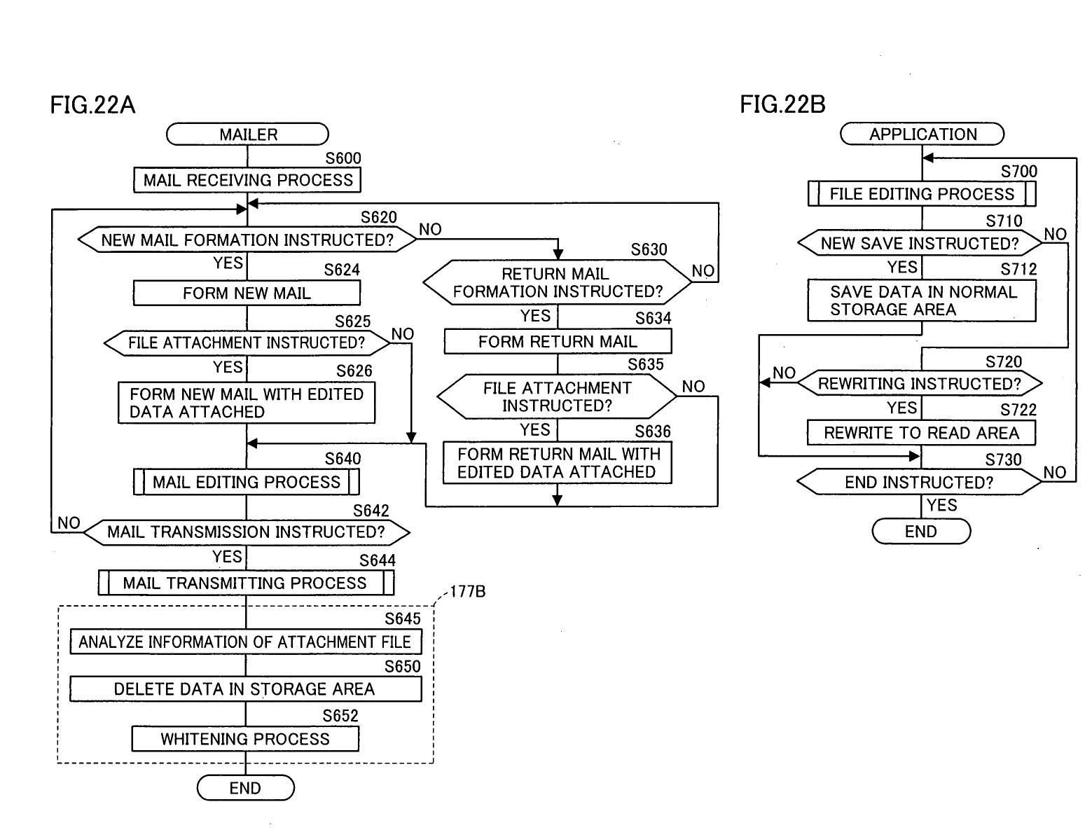

FIG. 22 is a flow chart representing the processes performed by mailer 300B and application program 310B in accordance with the third embodiment.

FIG. 22(A) is a flow chart representing the process performed by mailer 300B in accordance with the third embodiment. FIG. 22(B) is a flow chart representing the process performed by application program 310B in accordance with the third embodiment.

The processes performed in steps S645, S650 and S652 are executed by mail management program 177B incorporated in mailer 300B as a plug-in.

Next, processes executed by mailer 300B and application program 310B of the present embodiment will be described with reference to FIGS. 20, 21 and 22.

Referring to FIG. 22, the process of step S600 is the same as that of step S100 described above, and therefore, detailed description will not be repeated. Next, the flow proceeds to step S620.

When the user double-clicks that file which has been attached to a received mail and saved by mailer 300B in a prescribed folder by mouse 162, application program 310B is activated.

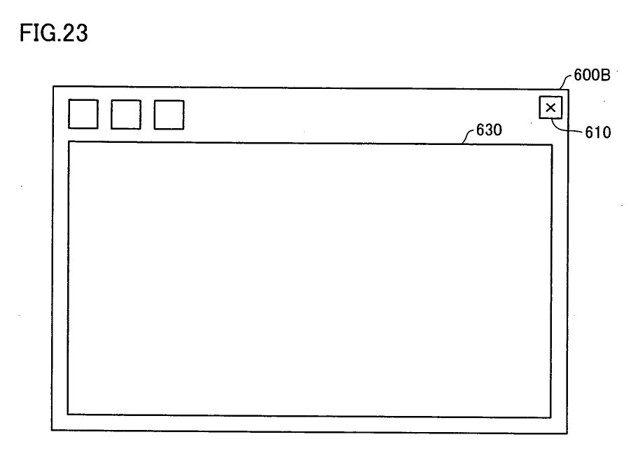

FIG. 23 shows an application program image 600B of the activated application program 310B. Application program image 600B appears as a window on display unit 80.

Referring to FIG. 23, application program image 600B is different from application program image 600 of FIG. 7 in that button 620 is not arranged. In other words, mail management program 177B is not incorporated in application program 310B. Except for this point, the image is the same as application program image 600, and therefore, detailed description thereof will not be repeated.

Again referring to FIG. 22, by application program 310B, first, the process of step S700 is performed.

In step S700, a file editing process is performed. The process of step S700 is the same as the process of step S200 described above, and therefore, detailed description thereof will not be repeated. Then, the flow proceeds to step S710.

In step S710, when application program 310B is forming a new file, whether there is an instruction to save the file (hereinafter also referred to as a new save instruction) or not is determined.

If it is determined in step S710 that there is a new save instruction, the flow proceeds to step S712. If it is determined in step S710 that there is not the new save instruction, the flow proceeds to step S720.

In step S712, application program 310B has the edition data that is being edited stored in normal storage area 142. Thereafter, the flow proceeds to step S730, which will be described later.

In step S720, when application program 310B reads a file (such as the file saved by mailer 300B in the prescribed folder as described above) stored in normal storage area 142 of storage unit 140 and is editing the read file, whether there is an instruction to save the file (hereinafter also referred to as rewriting instruction) or not is determined.

If it is determined in step S720 that there is a rewriting instruction, the flow proceeds to step S722. If it is determined in step S720 that there is not a rewriting instruction, the flow proceeds to step S730.

In step S722, a process of saving data in normal storage area 142 is performed. Specifically, to that area of normal storage area 142 of storage unit 140 from which the file has been read by application program 310B, the edition data that is being edited is rewritten by application program 310B. Thereafter, the flow proceeds to step S730.

In step S730, whether there is an instruction to finish application program 310B or not is determined. Specifically, whether the user single-clicked the button 610 on application program image 600B of FIG. 23 by mouse 162 or not is determined.

If it is determined in step S730 that the user has single-clicked button 610 by mouse 162, the process by the application program is finished. If it is determined in step S730 that the user has not single-clicked button 610 by mouse 162, the process of step S700 is repeated.

Next, in step S620, whether there is an instruction to form a new mail or not is determined. Specifically, whether the user has single-clicked button 822 on received mail viewing image 800 of FIG. 21 by mouse 162 or not is determined.

If it is determined in step S620 that the user has single-clicked button 822 by mouse 162, the flow proceeds to step S624. If it is determined in step S620 that the user has not single-clicked button 822 by mouse 162, the flow proceeds to step S630, which will be described later.

In step S624, a new mail is formed. Then, the flow proceeds to step S625.

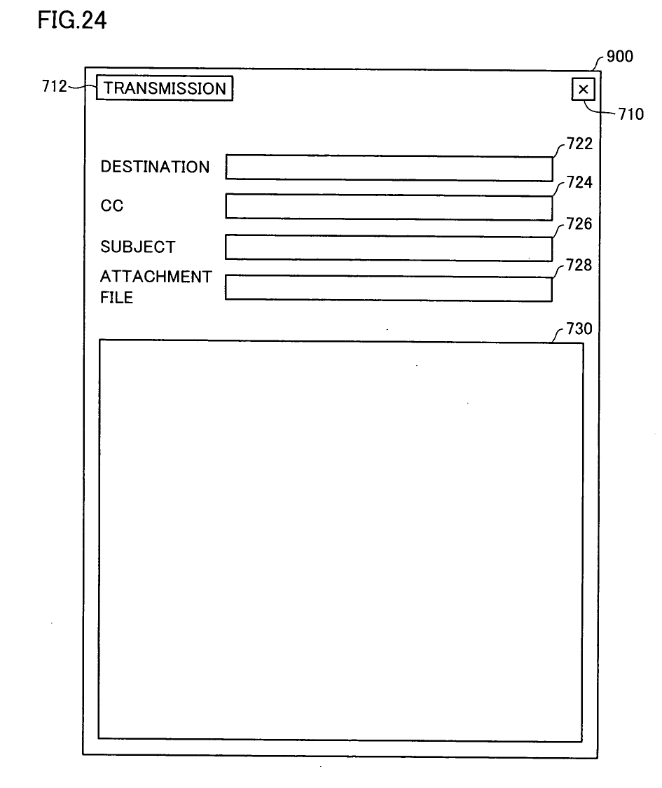

FIG. 24 is an image 900 representing the new mail. New mail image 900 appears as a window on display unit 80.

Referring to FIG. 24, new mail image 900 differs from new mail image 700A of FIG. 14 in that nothing is described in box 728. Except for this point, it is the same as new mail image 700A, and therefore, detailed description will not be repeated.

Again referring to FIG. 22, in step S625, whether there is a file attachment instruction or not is determined. The file attachment instruction is issued when the user drugs-and-drops the edition data stored in step S712 or S722 described above in normal storage area 142 to the new mail image 900 as a window.

If it is determined in step S625 that there is a file attachment instruction, the flow proceeds to step S626. If it is determined in step S625 that there is not a file attachment instruction, the flow proceeds to step S640.

In step S626, an edited-data-attached e-mail is formed. By way of example, the image of the thus formed edited-data-attached e-mail corresponds to new mail image 700A of FIG. 14. Then, the flow proceeds to step S640.

If it is determined in step S620 mentioned above that the user has not single-clicked button 822 by mouse 162, the flow proceeds to step S630.

In step S630, whether there is a return mail formation instruction or not is determined. Specifically, whether the user has single-clicked button 824 on received mail viewing image 800 by mouse 162 or not in the aforementioned mail selected state is determined.

If it is determined in step S630 that the user has single-clicked button 824 on received mail viewing image 800 by mouse 162 in the mail selected state, the flow proceeds to step S634. If it is determined in step S630 that the user has not single-clicked button 824 on received mail viewing image 800 by mouse 162 in the mail selected state, the process of step S620 is repeated.

In step S634, a return mail is formed. Then, the flow proceeds to step S635.

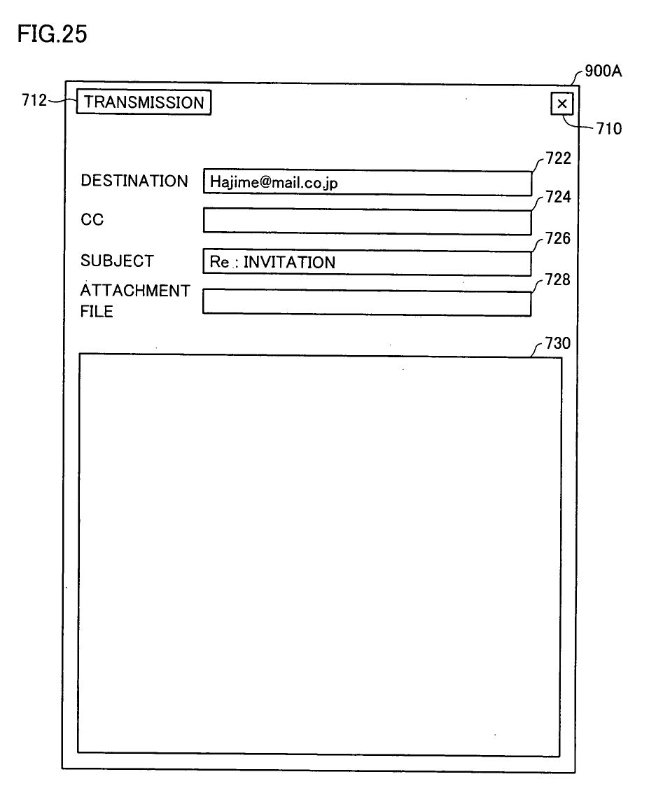

FIG. 25 is an image 900A representing a return mail. Return mail image 900A appears as a window on display unit 80.

Referring to FIG. 25, return mail image 900A differs from return mail image 700 of FIG. 11 in that nothing is described in display box 728. Except for this point, it is the same as return mail image 700, and therefore, detailed description thereof will not be repeated.

Again referring to FIG. 22, in step S635, whether there is a file attachment instruction or not is determined. The file attachment instruction is issued when the user drugs-and-drops the edition data stored in step S712 or S722 described above in normal storage area 142 to the return mail image 900A as a window.

If it is determined in step S635 that there is a file attachment instruction, the flow proceeds to step S636. If it is determined in step S635 that there is not a file attachment instruction, the flow proceeds to step S640.

In step S636, an edited-data-attached e-mail is formed. By way of example, the image of the thus formed edited-data-attached e-mail corresponds to return mail image 700 of FIG. 11. Then, the flow proceeds to step S640.

The process performed in step S640 is the same as that of step SI 70 described above, and therefore, detailed description will not be repeated. After the process of step S640, the flow proceeds to step S642.

In step S642, whether there is a mail transmission instruction or not is determined. Specifically, whether the user has single-clicked, by way of example, button 712 arranged on return mail image 700 of FIG. 11 by mouse 162 or not is determined.

If it is determined in S642 that the user has single-clicked button 712 by mouse 162, the flow proceeds to step S644. If it is determined in S642 that the user has not single-clicked button 712 by mouse 162, the process of step S620 is repeated.

The process of step S644 is the same as that of step S190 described above, and therefore, detailed description will not be repeated. Then, the flow proceeds to step S645.

In step S645, mail management program 1 77B analyzes the path through which the edition data attached to the mail formed in step S626 or S636 is stored. Then, the flow proceeds to step S650.

In step S650, the edition data stored in normal storage area 142 is deleted. Specifically, mail management program 177B instructs file deleting unit 323 to delete the edition data stored in normal storage area 142, based on the path information analyzed in step S645. In response to the deletion instruction, file deleting unit 323 deletes the edition data stored in normal storage area 142. Then, the flow proceeds to step S652.

In step S652, whitening process is performed. Specifically, mail management program 177B instructs whitening unit 324 to perform whitening, so as to fully prevent recovery of the edition data that has been deleted in step S650 in normal storage area 142. Whitening unit 324 performs the whitening process to fully prevent recovery of the deleted edition data, in response to the whitening instruction. Then, the process of mailer 300B ends.

In the present embodiment, the processes of steps S650 and S652 may be performed not by the mailer but by the application program.

By the foregoing process, even by an OS not having “WinFS”, the edition data attached to the edition-data-attached e-mail is automatically deleted by the process of mailer 300B after the edited-data-attached e-mail is transmitted, and therefore, hard disk capacity is not wasted. As a result, the storage area of the hard disk can effectively be utilized. Further, as the edition data is automatically deleted, it becomes unnecessary for the user to delete the edition data through troublesome manual operation.

Even if the edition data is confidential and unnecessary, whitening process is performed to fully prevent recovery of the edition data, and therefore, possibility of leakage of the confidential data is minimized.

In the present embodiment, a process is performed in which the edition data is stored in storage unit 140 that stores data in non-volatile manner. If a virtual drive is set by the OS in temporary data storage 122 that stores data in non-volatile manner and the edition data is stored not in storage unit 140 but in the virtual drive, the whitening process becomes unnecessary.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A program product that cooperates with an e-mail program having a function of transmitting/receiving an e-mail and a function of forming an e-mail with an application program data attached, causing a computer to execute the steps of:
storing an edition data processed by said application program in a storage unit of the computer;
passing information to form an edition-data-attached e-mail having said edition data stored in said storage unit attached, to said e-mail program;
deleting, in response to a notice from said e-mail program that said edition-data-attached e-mail has been formed, said edition data stored in said storage unit.

2. The program product according to claim 1, causing the computer to execute the steps of:
receiving a user's instruction to form an e-mail; and
in response to said instruction, storing the edition data being processed by said application program in a storage unit of the computer.

3. The program product according to claim 1, wherein
said edition-data-attached e-mail is a return mail to an e-mail received by said e-mail program.

4. The program product according to claim 3, wherein
said storage unit stores a mail address list;
said program product causing said computer to execute the steps of:
when said e-mail program has received an e-mail having data of said application program attached, reading information of the source of said e-mail having data of said application program attached; and
if the read information of the source is included in said mail address list, passing information for forming said edition-data-attached e-mail to said e-mail program.

5. The program product according to claim 1, having a module to operate as a plug-in in said application program.

6. The program product according to claim 1, causing the computer to further execute the step of
deleting said edition data such that recovery of said edition data from said storage unit is fully prevented.

7. The program product according to claim 1, wherein
said storage unit stores data in a non-volatile manner.

8. A program product that cooperates with an e-mail program having a function of transmitting/receiving an e-mail and a function of forming an e-mail with an application program data attached, causing a computer to execute the steps of: after an edition-data-attached e-mail having the edition data formed by said application program and stored in the storage unit attached is transmitted by said e-mail program, analyzing information of said edition data attached to said edition-data-attached e-mail; and
deleting said edition data stored in said storage unit in accordance with the analysis of said edition data.

9. The program product according to claim 8, wherein
said edition-data-attached e-mail is a return mail to an e-mail received by said e-mail program.

10. The program product according to claim 8, having a module to operate as a plug-in in said application program.

11. The program product according to claim 8, causing the computer to further execute the step of
deleting said edition data such that recovery of said edition data from said storage unit is fully prevented.

12. The program product according to claim 8, wherein
said storage unit stores data in a non-volatile manner.

13. A program product that cooperates with an e-mail program having a function of transmitting/receiving an e-mail and a function of forming an e-mail with an application program data attached, causing a computer to execute the steps of:
receiving a user's instruction to form an e-mail;
in response to the instruction, storing an edition data being processed by said application program in a storage unit of the computer; and
passing information for forming an edition-data-attached e-mail having said edition data stored in said storage unit attached, to said e-mail program.

14. A program product that cooperates with an e-mail program having a function of transmitting/receiving an e-mail and a function of forming an e-mail with an application program data attached, causing a computer to execute the steps of:
receiving an instruction to form an e-mail having an edition data formed by said application program and stored in a storage unit of said computer attached;
reading attribute of said stored edition data in response to the instruction; and
passing information to form the e-mail to said e-mail program, in accordance with said read attribute of the edition data.

15. The program product according to claim 14, wherein
said e-mail program forms an e-mail based on said read attribute of the edition data.

16. The program product according to claim 14, wherein
said information is return information to an e-mail received by said e-mail program.
